(19) United States
(12) Patent Application Publication
(10) Pub. No.: US 2015/0188389 A1
(43) Pub. Date: Jul. 2, 2015

(54) Energy Harvesting System with Multiple Cells

(71) Applicants: Dujiang Wan, Fremont, CA (US); Ge Yi, San Ramon, CA (US); Timmu Xintian Yi, San Ramon, CA (US)

(72) Inventors: Dujiang Wan, Fremont, CA (US); Ge Yi, San Ramon, CA (US); Timmu Xintian Yi, San Ramon, CA (US)

(73) Assignees: Dujiang Wan, Fremont, CA (US); Timmu Xintian Yi, San Ramon, CA (US); Ge Yi, San Ramon, CA (US)

(21) Appl. No.: 14/145,931

(22) Filed: Jan. 1, 2014

(51) Int. Cl. H02K 7/18; F03G 5/06; F03G 7/08

(52) U.S. Cl. CPC H02K 7/1876; F03G 7/08; F03G 5/06

(57) ABSTRACT

An energy harvesting system made of array of miniaturized pseudo-linear oscillators, i.e., energy harvesting cells, each of which comprises a free moving hard magnet floating structure supported by sophistically designed magnetic levitation mechanism, is proposed to exact and store useful energy from the broad band natural kinetic energy based on Faraday's law of induction. The array of miniaturized energy harvesting cell can be made using volume production wafer process. The miniaturized energy harvesting system as power supply can be integrated into wireless sensor system, or as part of energy supply subsystem, directly built into portable or wearable devices. Four integrated architectures of the proposed energy harvesting system with wireless sensor have been discussed. The scaled up energy harvesting system can be used to power city street lights by converting and storing useful energy from road traffic movements. The proposed energy harvesting system along with specified designed large capacitor and rechargeable battery can also be installed into vehicle to improve the vehicle's energy utilization efficiency by harvesting energy from the vehicle's movement.

### FIELD OF INVENTION

The invention is related to energy harvesting system, which can efficiently convert the broad band low frequency kinetic energy to electrical energy, and store the useful energy to power street lights, wireless sensor or portable and wearable electronic devices. The energy harvesting system can also be installed into vehicle with specified designed large capacitor and rechargeable battery to supply power for gas engine starts or as second power source for plugin or hybrid vehicle.

### BACKGROUND ART

Despite continual progresses on both battery technology and the reductions of size and power consumption of wireless sensors, the applications of wireless sensors are limited due to the requirement of frequent battery replacement or re-charging. Meanwhile, conventional battery is not environmental friendly since it contains lots of hazardous materials, and makes poison byproducts and dangerous gases. Self-powered wireless sensors are necessary for their applications, such as people caring, health monitoring, environmental monitoring, and biomedical sensing, in which embedded energy harvesting system can supply power for the sensors' working by converting broad band low frequency (typically, less than 80 Hz) kinetic energy to electrical energy. As long as the size reduction of wireless sensors, the embedded energy harvesting system also needs to be miniaturized.

Portable and wearable electronic devices have been changing our life. With optimized designs of CPU and GPU, they can carry out more sophistic functions. All portable and wearable electronic devices are powered by batteries that require often re-charging. It could be extremely attractive to build an energy harvesting system in a portable or wearable device to supply power in case of running out of battery by continuously extracting and storing useful energy efficiently from the device user's movement.

Global warming is the single biggest environmental and humanitarian crisis of our time. While green energy technology based on solar and wind have been promoted for many years, they have their limitations. On one hand, solar energy technology is largely based on silicon technology, whose manufacture processes are not environmental friendly at all. On the other hand, harvesting electricity from wind needs large infrastructure investment. An energy harvesting system built underneath city road, which continuously extracts and stores useful energy efficiently from traffic induced road vibration energy, can be used to power city lighting system. It is an important and environmental friendly green technology to help us solving global warming by reducing greenhouse gas.

Typical energy harvester design is based on linear mass-spring mechanical oscillator system to convert mass-spring oscillations caused by its environmental vibrations into electric energy whose energy conversion efficiency is limited by the resonance frequency of the energy harvester. So, for broad band natural kinetic energy, only small fraction of the available energy can be converted into electric energy. Most of commercially available energy harvesters on the market have very narrow energy conversion bandwidth. Increase of the energy conversion bandwidth is crucial for energy harvester's efficiency and functionality. One of approaches to increase the bandwidth is switching the energy harvester from purely linear oscillator to nonlinear oscillator (B. P. Mann and N. D. Sims, Journal of sound and Vibration 319, 515-530, 2009). FIGS. 1 (a) and (b) show a nonlinear harvester design and its force-displacement nonlinear relationship. FIG. 1 (c) shows the power generation of nonlinear harvester compared to linear harvester (C. Lee, D. Stamp, N. Kapania, J. 0. Mur-Miranda, Proc. of SPIE Vol. 7683, 76830Y). Both simulation and experiment data obtained by C. Lee, et al, show that the nonlinear oscillator has more than one stable state after the jump of frequency. The response of the nonlinear oscillator to random broad band excitations prefers to stay at low energy state. The external constant perturbations are required to maintain nonlinear oscillator at desirable high energy states. This drawback limits the capacity of nonlinear oscillator as a broad band energy harvester.

We proposed a new versatile broad band energy harvesting system made of array of multiple pseudo-linear oscillator cells in this invention. Each pseudo-linear oscillator cell, as an energy harvester, works at a specified resonant frequency, which could be different from that of other cells. All cells together cover broad band vibrations to efficiently convert the available energy into electric energy.

### SUMMARY OF THE INVENTION

In this invention, a new broad band energy harvesting system, which is made of array of micro (compared to system dimensions) pseudo-linear oscillator cells, is proposed. Each cell as an energy harvester has a pancake induction coil with hundreds of turn and a free moving floating permanent magnet structure that is supported by a sophistically designed magnetic levitation mechanism to work as a pseudo-linear oscillator at a specified resonant frequency. Any relative movement between the coil and the floating permanent magnet caused by environmental vibrations and host movement will generate electricity in the coil according to Faraday's law of induction. Each cell can efficiently transfer mechanical energy around its specified resonant frequency to electric energy. Each cell works at its own resonant frequency, which could be different from that of other cells. Array of micro pseudo-linear oscillator cells together within the system cover broad band vibrations to make the whole system becomes an energy harvester covering broad band vibration. A set of built-in simple RC (Resistor and Capacitor) circuit whose resonant frequency matches each micro pseudo-linear oscillator cell's working frequency can be made monolithically either on top or at the bottom of each cell for best circuit efficiency.

This invented energy harvesting system could have thin and small form factor that can be made relying on semiconductor and microelectromechanical system (MEMS) wafer processes in large volume production. The system can easily be either integrated with wireless sensors, portable devices and wearable devices or built as an independent apparatus to provide electricity charging to portable devices and wearable devices. This invented energy harvesting system, particularly the core of design concept, can also be scaled up to continuously extracts and stores useful energy efficiently from traffic caused road vibration energy that can be used to power city lighting system.

The energy harvesting system can also be installed into vehicle to gather and store the energy from the vehicle's movement. The system, along with specified designed large capacitor and rechargeable battery, can be used as either independent accessory or additional built-in fail-safe system to battery system, which supply power for gas engine starts or as second power source for plugin or hybrid vehicle.

The novel design cuts down the friction induced energy loss by using magnetic levitation as well as surface patterning to reduce surface contact area approaching to near-zero surface contact.

### BRIEF DESCRIPTION OF THE DRAWINGS

FIG. 1 shows a nonlinear energy harvester design, its force-displacement nonlinear relationship, and power generation of nonlinear harvester compared to linear harvester (C. Lee, D. Stamp, N. Kapania, J. O. Mur-Miranda, Proc. of SPIE Vol. 7683, 76830Y).

FIG. 2 illustrates one of the embodiments for proposed energy harvesting system (a) Single row of cells. (b) Multiple rows of cells. (c) Superposition of harvested energy by multiple energy harvesting cells working at different resonant frequencies.

FIG. 3 shows a schematic for one of micro energy harvesting cells.

FIG. 4 illustrates the floating magnet's linear force-displacement response within the proposed micro energy harvesting cell: (a) Floating magnet 401 at its equilibrium position; (b) Floating magnet 401 moving away from its equilibrium position; (c): Force-displacement response of floating magnet 401, Note: Elastic restoring force pointing to right side is defined as positive force.

FIG. 5 shows a schematic for one of tunable energy harvesting cells.

FIG. 6 shows a schematic for another one of tunable energy harvesting cells.

FIG. 7 shows different configurations of the proposed energy harvesting system's applications with different wireless sensors: (a) A basic application configuration of an energy harvesting system (EHS) with a work unit (WU); (b) A single EHS/ESR and dual batteries application configuration of the proposed energy harvesting system (EHS) with a work unit (WU); (c) Self-powered falling detection system; (d) Dual EHS/ESR groups and dual batteries System.

FIG. 8 shows a self-powered street lighting system.

### DETAILED DESCRIPTION

The following description is provided in the context of particular designs, applications and the details, to enable any person skilled in the art to make and use the invention. However, for those skilled in the art, it is apparent that various modifications to the embodiments shown can be practiced with the generic principles defined here, and without departing the spirit and scope of this invention. Thus, the present invention is not intended to be limited to the embodiments shown, but is to be accorded the widest scope consistent with the principles, features and teachings disclosed here.

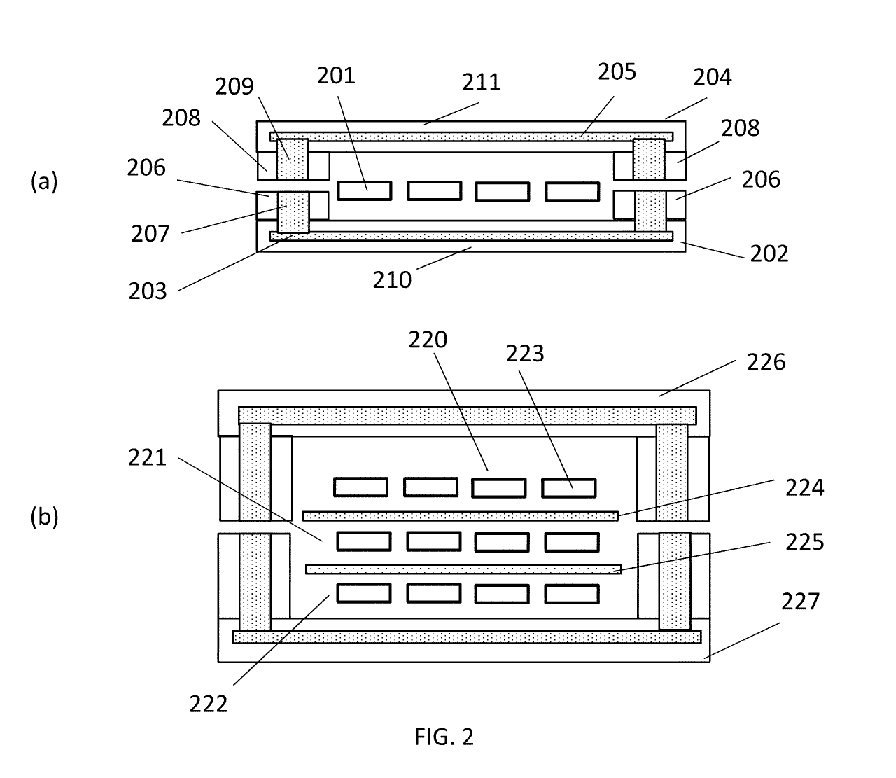

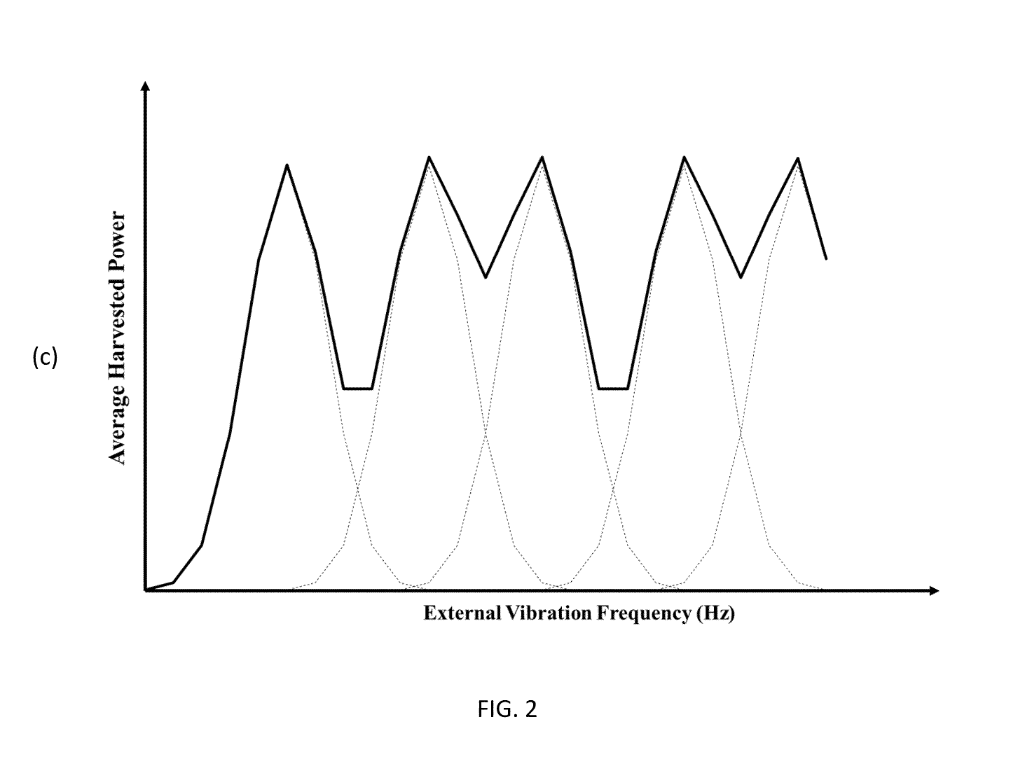

FIG. 2(a) shows one of the embodiments of the proposed energy harvesting system with array of energy harvesting cell 201 arranged as one single row of cells, while FIG. 2(b) shows another embodiments, whose energy harvesting cells are arranged in multiple rows. For simplicity, no solder pads for the assembly are shown in FIG. 2.

In FIG. 2(a) of the proposed energy harvesting system with the single row of energy harvesting cells, the bottom packaging frame 202 comprises main body 210 with soft magnetic skeleton 203, and bottom enclosing structure 206 with soft magnetic insertion 207, which is connected to soft magnetic skeleton 203. Similarly, the top packaging frame 204 comprises main body 211 with soft magnetic skeleton 205, and top enclosing structure 208 with soft magnetic insertion 209, which is connected to soft magnetic skeleton 205. Once assembled, the 205, 209, 207 and 203 forms a fully soft magnetic closure as magnetic shield to protect the enclosed array of the energy harvesting cells 201 from the external magnetic field's disturbing. It also shields the magnetic fringe field emitted from the internal magnetic structures, which is particularly important for use as energy supply system for medical devices. The array of the energy harvesting cell 201 can be made simultaneously by either volume production wafer processes or printing/electroplating method depending on the dimensions of 201. Each pseudo-linear oscillator cell by design has different resonant frequency.

In FIG. 2(b) of the proposed energy harvesting system with multiple rows of energy harvesting cells, the energy harvesting cells 220 are arranged in multiple layers rows 221, 222 and 223 while separated by soft magnetic layers 224 and 225, respectively. Soft magnetic layers 224 and 225 are used to decouple the magnetic interference of adjacent layers. The energy harvesting cells 220 are enclosed between two packaging frames 226 and 227 with soft magnetic skeleton. Three-row array of cells are shown here in FIG. 2, but the number of rows is not limited, depending on particular application design. All the multiple rows of the energy harvesting cell with small dimensions can be made using wafer processes on substrate layer by layer monolithically or made as one single layer then stack them together to form multiple rows once dicing into small chips.

Each cell shown in FIG. 2(a) and FIG. 2(b) works at its own resonant frequency, which could be different from that of other cells. Array or arrays of that kind of miniaturized pseudo-linear energy harvesting cells together within the system cover broad band vibrations to make the whole system becomes an energy harvester covering broad band frequency of kinetic energy. FIG. 2(c) shows the superposition of harvested energy by multiple energy harvesting cells working at different resonant frequencies in such energy harvesting system.

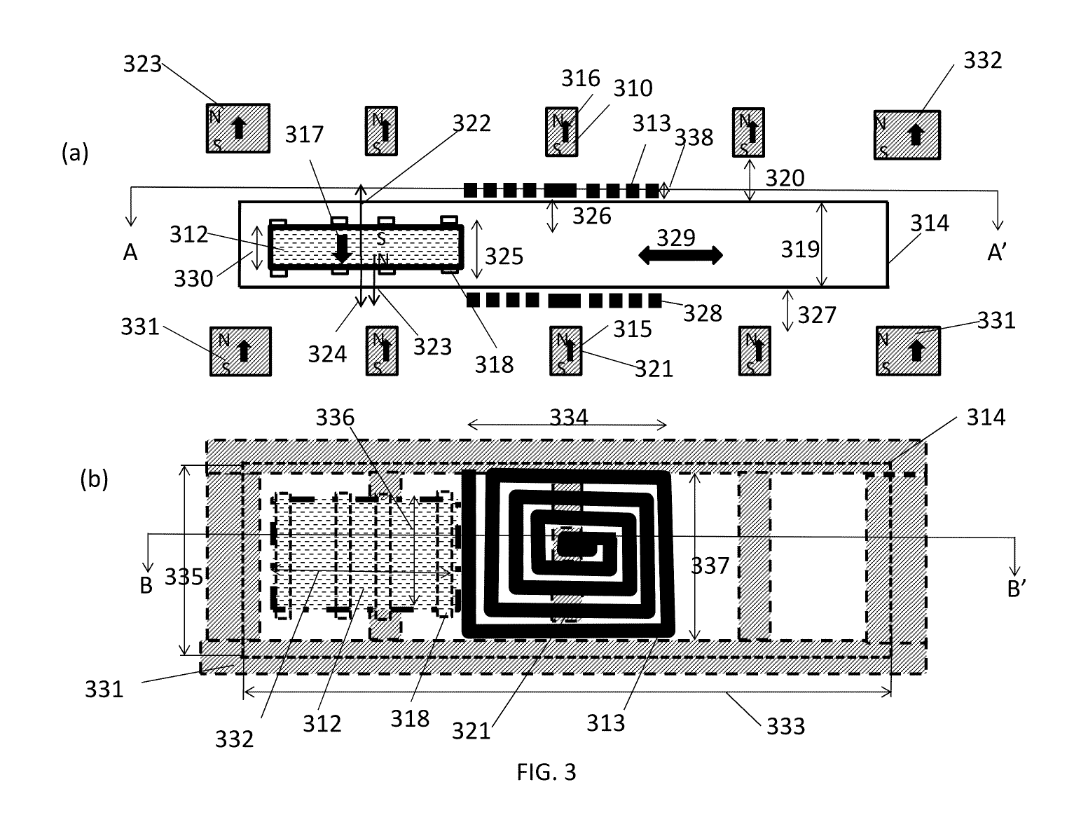

FIG. 3 shows schematically the key components within one energy harvesting cell. FIG. 3(a) illustrates the cross section view along B-B′ line shown in FIG. 3(b) while FIG. 3(b) show the projected views along A-A′ line shown in FIG. 3(a). The energy harvesting cell comprises two induction pancake coils 313 and 328, a hollow tube 314, a floating structure containing hard magnet 312 inside the tube 314, bottom and top magnets 331 and 332 siting at the ends of the hollow tube 314, specially-arranged top and bottom magnets 310 and 321 outside the hollow tube 314.

Two pancake coils 313 and 328 are shown in this embodiment. Multiple coils can be further arranged as top coil 313 and bottom coil 328 shown here. For the simplicity, it is assumed that the coil 313 and coil 328 have the same of size of length 334 and width 337. The thickness 338 of coil is determined by the designs of coil resistance and magnetic performance. The thicker the better from coil resistance design point view, but is restricted by the magnetic design that requires the flux from the hard magnet within floating structure 312 passing through the coil easily.

The hollow tube 314 has dimensions of length 333, width 335 and height 319 while the dimensions of hard magnet floating structure 312 has length 332, width 336, and height 325. The hard magnet floating structure 312 can have surface patterned structure 318 to reduce the surface contact area between the hollow tube 314 and the floating structure 311 for friction reduction. The width 337 of two pancake coils 313 and 328 closely matches the tube's width 335. The hollow tube 314 is designed to have enough length 333 to gain the maximum magnetic flux change through the coils 313 and 328 by accommodating the movement of the floating structure 312 with length of 332 in the direction 329 inside the tube 314 under influence of external movement.

All the magnets 332, 331, 310, 321 outside the hollow tube has the same magnetization orientation representing by arrow 316 and 315 opposite to the magnetization 317 of the hard magnet in the floating structure 312 providing a magnetic levitation mechanism. The vertical component of the magnetic repelling force 322 between bottom magnets 331/315 and 312 is balanced by the vertical component of the repelling force 324 between top magnet 332/310 and 324 and gravity force 323 of the floating structure. Therefore, the hard magnetic floating structure can levitate and move from left to right side, and vice versa, inside tube 314.

The height of magnet 330 in the floating structure 312 has to be larger than the sum of distance 326 of the magnet 330 to coil and coil thickness 338 so that the magnetic flux from the magnet 330 in floating structure 312 can easily penetrate through the coil when it passes through the gap between the top and bottom induction coils 313 and 328. The distance 320 between the top magnets and the hollow tube 314 and the distance 327 between the bottom magnets and the hollow tube 314 are optimized to provide magnetic levitation mechanism for the hard magnetic floating structure 312 by balancing the forces of 322, 324 and 323. The hollow tube 314 needs have enough height 319 to accommodate the floating structure 312 with height of 325 moving in the direction 329 inside the tube 314 with minimum of surface contact.

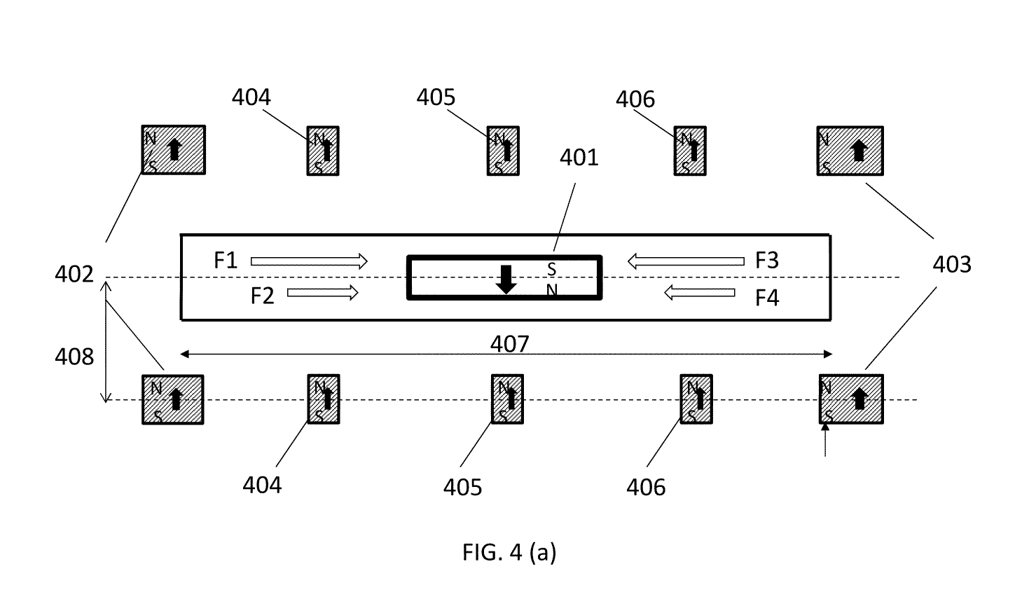

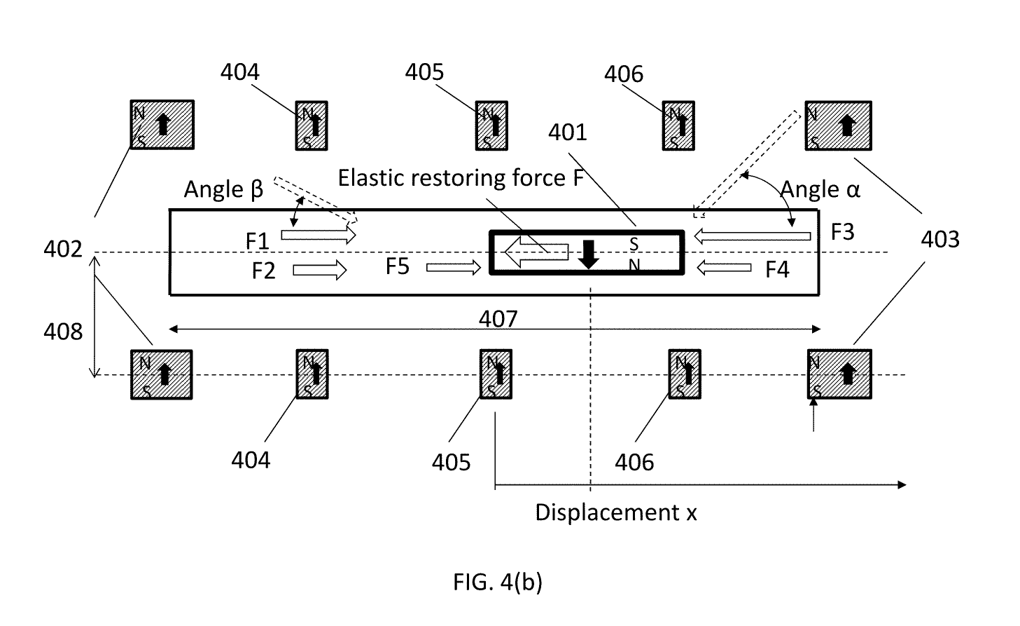

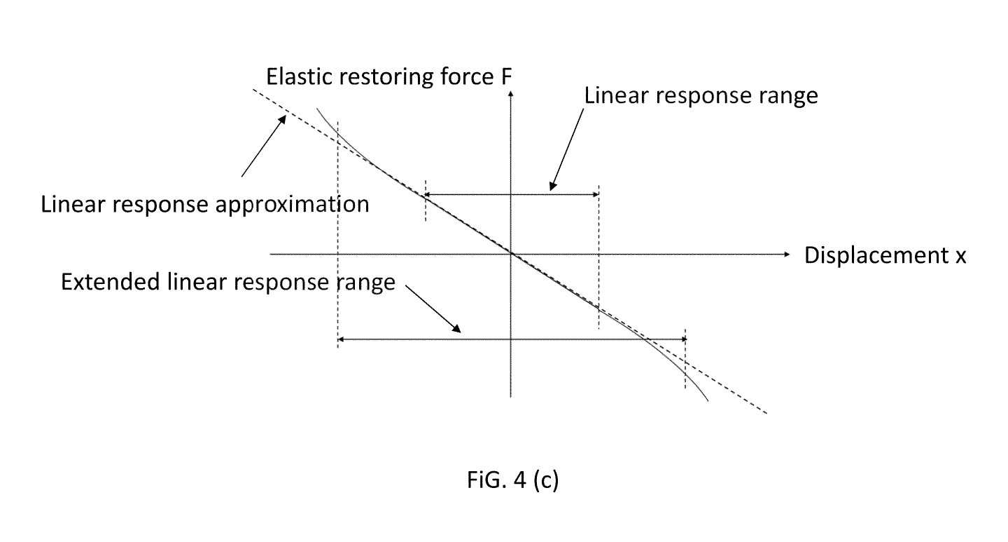

FIG. 4 illustrates how the magnetic floating structure 401 within the micro energy harvesting cell responses to external vibration. As shown in FIG. 4(a), the net horizontal magnetic repelling forces F1 and F2 obtained by pairs of magnets 402 and 404, respectively, are balanced by the net horizontal magnetic repelling forces F3 and F4 obtained by pairs of magnets 403 and 406, respectively, when the floating structure 401 is at its equilibrium position. There is no magnetic repelling force along the horizontal axis of the micro energy harvesting cell. The external input of mechanical energy drives the floating structure 401 away from its equilibrium position as shown in FIG. 4(b). Even though the horizontal magnetic repelling forces F4 and F5 that obtained by pairs of magnets 406 and 405, respectively, balance each other in this scenario, there is net elastic restoring force F acting on the floating structure 401 due to the unbalance of the horizontal magnetic repelling forces F1, F2 and F3 shown in FIG. 4(b).

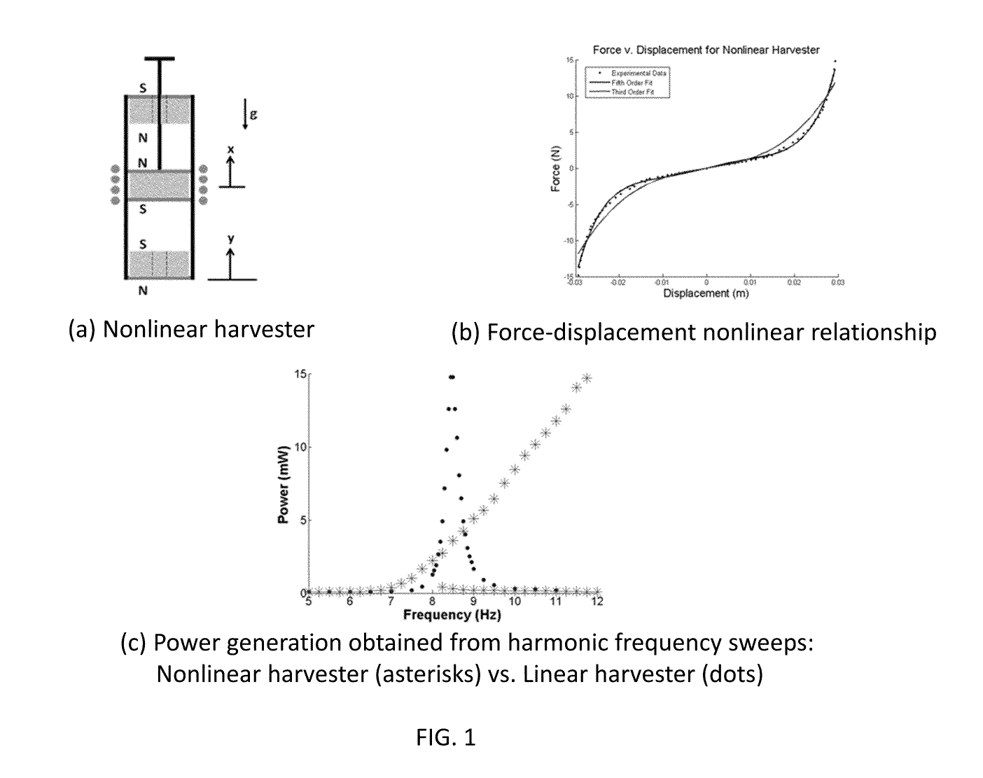

In general, the relationship between the displacement and the elastic restoring forces is nonlinear in large displacement range due to the nature of magnetic repulsion. While the oscillator's displacement is approximately linear with the elastic restoring force near the equilibrium position, the oscillator's response stiffens when it moves further away from its equilibrium position as shown in FIG. 1(b). However, for our proposed micro energy harvesting cell design, only the horizontal components of magnetic repelling forces contribute to the elastic restoring force F, which is the function of relative position angles α and β shown in FIG. 4(b), when the magnetic floating structure 401 moves away from its equilibrium position. As shown in FIG. 4(c), our proposed magnetic floating structure 401 will have much soft response than the center magnet shown in FIG. 1(a). The soft response of our proposed magnetic floating structure 401 significantly extends its linear response range shown in FIG. 4(c). Meanwhile, the displacement of the floating structure 401 is limited by the constraint of the hollow tube length 407. Hence, our proposed micro scale size energy harvester cell in this invention has a pseudo linear oscillator whose working frequency, i.e., resonant frequency, depends on the mass of the floating structure 401 and the cell's magnetic design, such as the center to center vertical gap 408 between the floating magnetic floating structure 401 inside the hollow tube and the outside magnets.

Different tube length and magnetic arrange as well as multilayer configuration for control the distance between the surrounding magnets respect to the floating magnet are effective method to control resonant frequency.

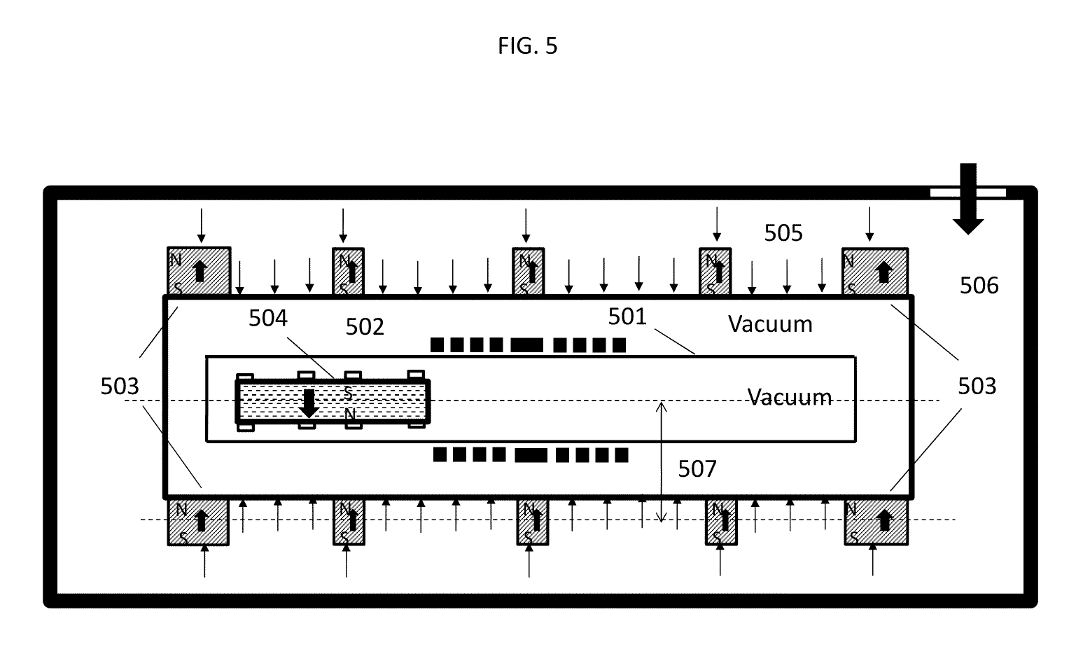

FIG. 5 shows one of the embodiments of tunable energy harvesting cells that is similar as that shown in FIG. 3. The hollow tube 501 is surrounded by a vacuum space 502, which is formed by close loop metal thin film. The magnets 503 outside the hollow tube 501 firmly attach to the metal thin film shown in FIG. 5. By introducing gas into the space 506, we can add the pressure 505 on the outside of thin metal film. As mentioned above, the resonant frequency of the micro energy harvesting cell can be tuned by adjusting the center to center vertical gap between the floating magnetic floating structure inside the hollow tube and the outside magnets. So, the resonant frequency of the micro energy harvesting cell shown in FIG. 5 is tunable by adjusting the pressure 505 that will change the gap 507 between the floating magnet 504 and the outside magnets 503. The details of this tuning technique by adjusting gas pressure will be disclosed in a separated disclosure.

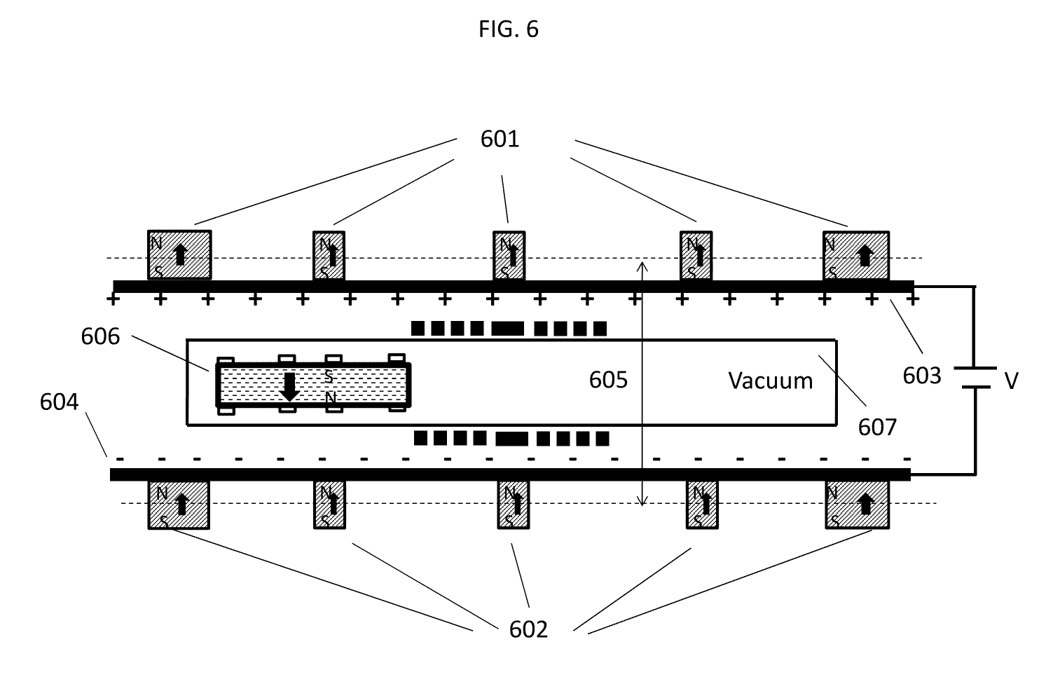

FIG. 6 shows another one of the embodiments of tunable energy harvesting cells that is similar as that shown in FIG. 3 too. The magnets 601 and 602 firmly attach to the metal or dielectric thin film plates 603 and 604, respectively, shown in FIG. 6. The electrostatic force between two plates 603 and 604 depends on the applied voltage V that will determine the center to center gap 605 c between plates 603 and 604. As pointed out before, the resonant frequency of the floating magnet 606 within the hollow tube 607 can be tuned by adjusting the center to center gap 605 between the metal plates 603 and 603. Therefore, the resonant frequency of the micro energy harvesting cell shown in FIG. 6 is tunable by adjusting the voltage V. More details of this tuning technique using electrostatic force will be disclosed in a separated disclosure.

All the components shown in FIG. 3, FIG. 5 and FIG. 6 can be easily fabricated using volume production methods, particularly semiconductor and MEMS wafer processes in a cost effective manner. The design of pancake coils can be produced easily with low cost masks and plating methods while thicker magnet (5 to 100 micrometers) in floating structure 312 can be fabricated by plating as well. The rest magnets can be either made by sputtering or also electroplating. The details of electroplating permanent magnet technique and the tool's configuration will be disclosed in another separated disclosure. The hollow tube shown in FIG. 3, FIG. 5 and FIG. 6 and the vacuum and open spaces and open spaces 502 and 506 shown in FIG. 5 can be made by well-known MEMS processes using sacrificial filling material following by wet etch after all the rest components is built. Moreover, the overall vertical dimensions can be control well below one mm with multiple rows of cells all fabricated on same substrate, which can be semiconductor, or ceramic, or glass, or even plastic. If semiconductor is used, the application-specific integrated circuit (ASIC) as well as energy stored large capacitors can also be made relatively easy in the substrate.

In general, the wireless sensor can work in active or passive mode, depending on its' application requirements. The proposed energy harvesting system can be integrated into wireless sensor system to provide supply for wireless sensor's power consumption.

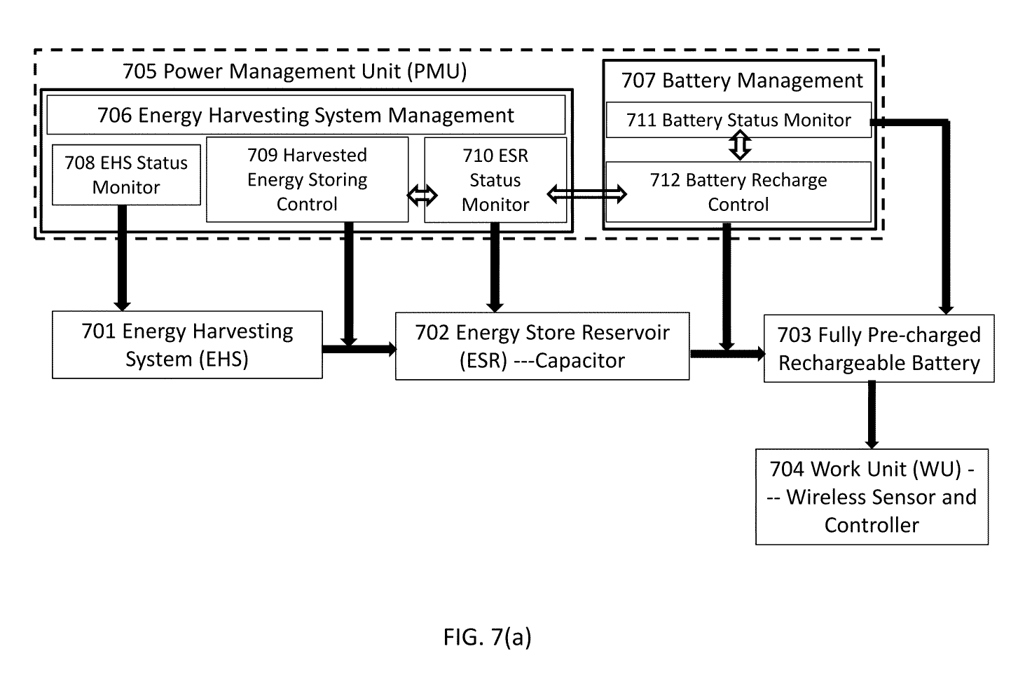

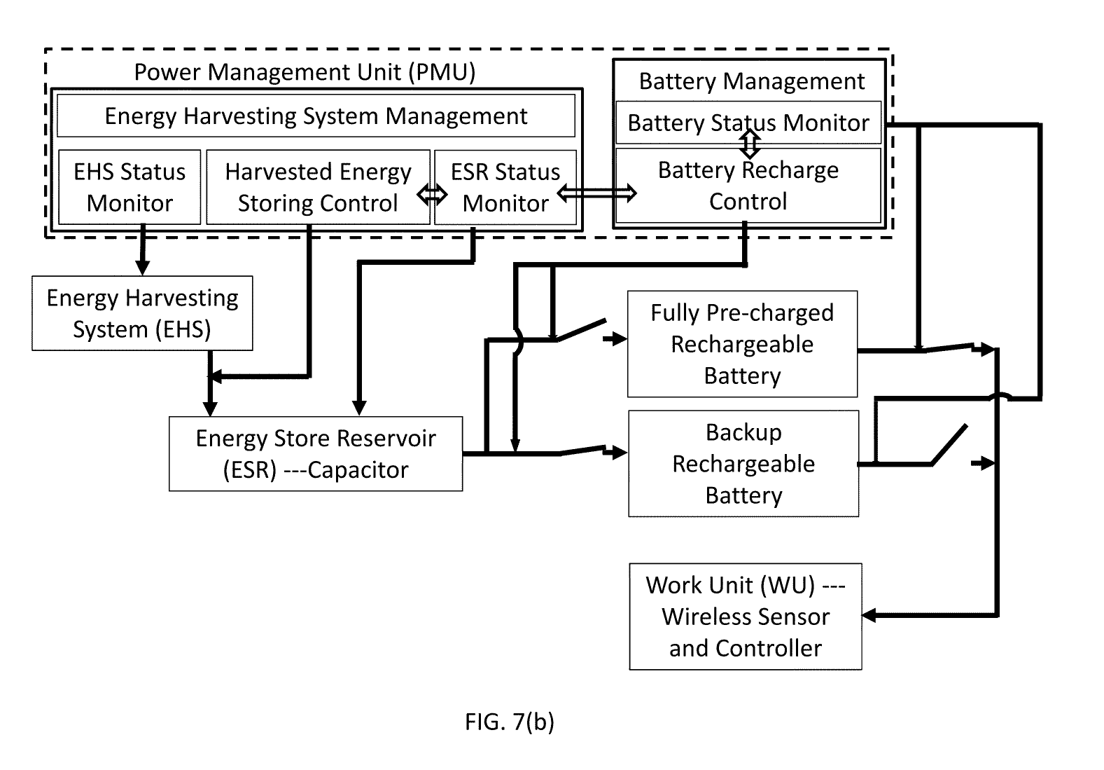

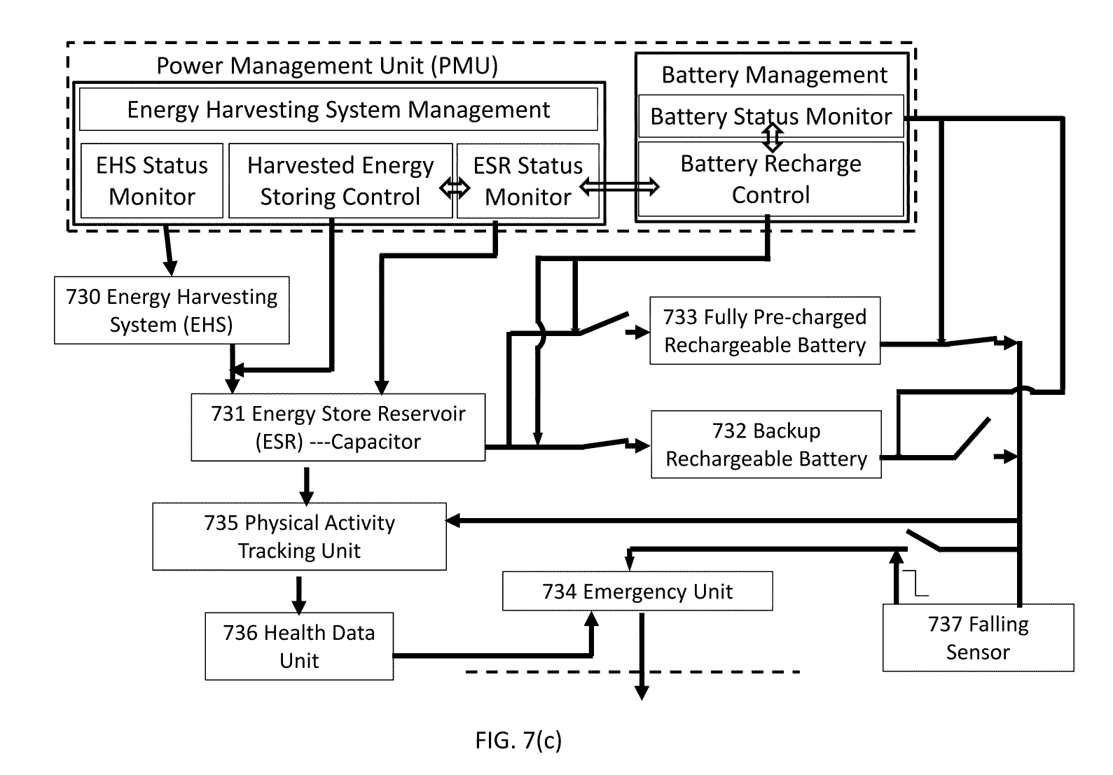

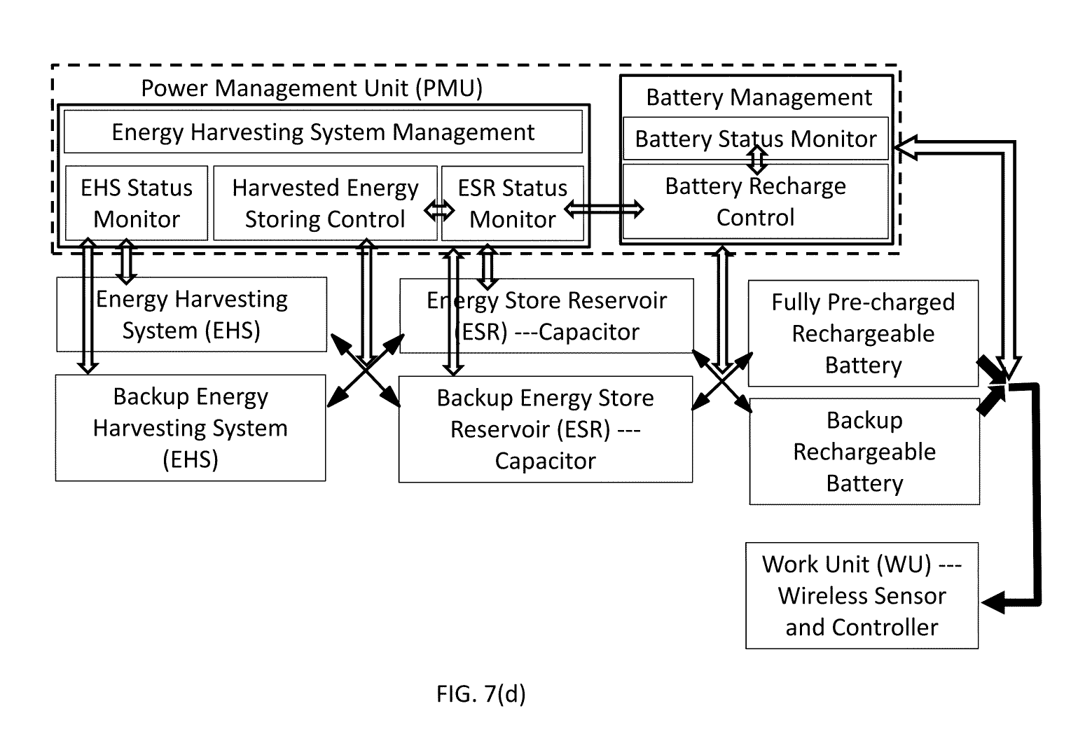

FIG. 7(a) shows a basic application configuration of the proposed energy harvesting system linked with a work unit, i.e., wireless sensor. It comprises a proposed energy harvesting system (EHS) 701, an energy store reservoir (ESR) 702, a rechargeable battery 703 and a work unit 704. Usually, a capacitor is used as the 702 ESR. The useful energy harvested by the 701 EHS will be stored temporally in the ESR 702. The rechargeable battery 703 is fully pre-charged at beginning to power the work unit. The statuses of EHS 701, ESR 702 and battery 703 are monitored by power management unit 705. The power management unit 705 also manages harvested energy storing and battery recharging processes. This kind of configuration system has lots of applications. One of its applications is in the fields of exercise or sports' training. It can be used to build individual exercise's track or help athletes tracking their progresses in their sports' trainings by monitoring the harvested energy data from the exercise or physical training.

The power management unit 705 comprises of two sub-management systems, i.e., energy harvesting system management 706 and battery management 707. Two preset thresholds are used to manage ESR 702 working correctly. The ESR 702 will collect energy from EHS 701 when its stored energy level is below the preset bottom threshold. When both the stored energy level in the ESR 702 is higher than the preset upper threshold and the battery capacity checked by battery management 707 is below its preset low limit, the ESR 702 will start to charge the battery 703. The energy harvest system management further comprises EHS status monitor 708, harvest energy storing control 709 and ESR status monitor 710, while battery management 707 comprises at least battery status monitor 711 and battery recharge control 712. The detail logic and electric circuit designs of the power management unit 705 will be discussed in a separated power management disclosure.

FIG. 7(b) shows a single EHS/ESR and dual batteries configuration. At very beginning, the fully pre-charged rechargeable battery powers the work unit. Meanwhile, the EHS/ESR together harvests useful energy from the environment, and charge the backup rechargeable battery. When the first battery almost runs out its energy, the system will switch to backup battery to power the work unit, and the EHS/ESR together will charge the first battery and vice versa. As pointed out previously, wireless sensor's application in remote or dangerous environmental monitoring is limited by frequent battery replacement. The single EHS/ESR and dual batteries system is a self-powered system that only needs a first time battery charging to turn on the system. Hence, it can be used for remote or dangerous environmental wireless monitoring.

Both configurations shown in FIG. 7(a) and FIG. 7(b) are active mode systems. They can work in passive mode too by adding a trigger sub-system into the configurations, such as RF ID.

FIG. 7(c) shows a self-powered falling detection system, similar as the system shown in FIG. 7(b) but working in passive mode. Under normal circumstance, the energy harvesting system (EHS) 730 keeps harvesting useful energy from carrier's regular physical activities, and storing the energy in capacitor (ESR) 731 and batteries 732, 733, but the emergency unit 734 is off for energy saving. Meanwhile, the harvested energy data are used to track the carrier person's physical activities, unit 735, and store in his/her health data unit 736. If a falling event happens due to an accident, the falling sensor 737 will trigger on the emergency unit 734 to collect the health information from the health data unit 736 and call the carrier's emergency contact person for help immediately through wireless communication network. The emergency unit 734 will trigger a series of events, which needs much more energy. To keep the 734 in sleep mode preserves energy saving for the overall system.

For wireless sensor applications in some fields, such as people caring, health monitoring, tsunami or earthquake detecting, toxic material tracking, redundancy to increase the reliability of the system is a must. FIG. 7(d) shows a dual EHS, dual ESR and dual batteries system that consists of a PMU, two EHS, two ESR groups, two rechargeable batteries and one WU. The system is powered by any combination of one EHS/ESR/battery group, and the other components are for backup. Whenever the active component either EHS or ESR is out of function, the other EHS or ESR component will automatically take the role to power the system, and PMU will send out a call for replacement. The redundancy and self-check function in the system shown in FIG. 7(d) makes the system fail-safe and work correctly.

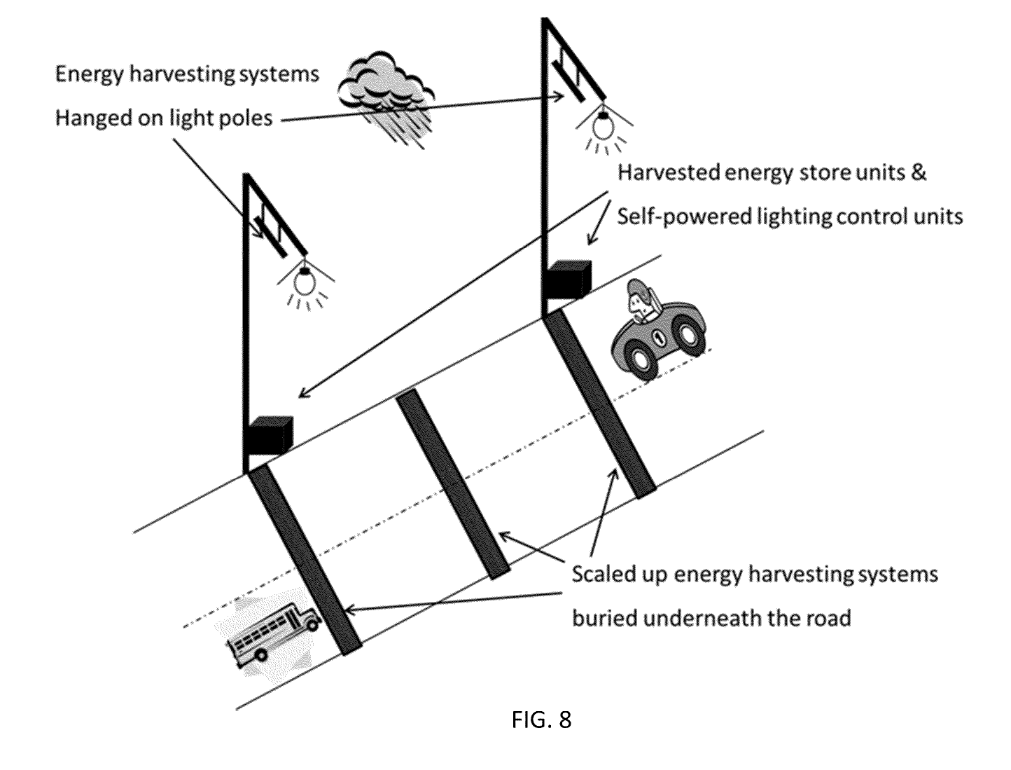

As mentioned previously, the proposed energy harvesting system is an environmental friendly green technology. It can be scaled up to continuously extract and store useful energy from road vibration energy caused by traffic to power city lighting system. FIG. 8 shows schematic of such self-powered city lighting system. The scaled up proposed energy harvesting systems are buried underneath the road to collect useful energy from road traffic movements, and store the energy into harvested energy store unit for street light use in evening.

Losing power due to bad weather such as storm is not unusual for both street and traffic light systems. The proposed energy harvesting system can be hanged on the lighting poles. It will convert the storm's energy into electricity for street and traffic lights' use during a bad weather caused emergency.

The proposed energy harvesting system can also be installed into vehicle to gather and store the energy from the vehicle's movement to improve the vehicle's energy utilization efficiency. Along with specified designed large capacitor and rechargeable battery, it can be used as either independent accessory or additional built-in fail-safe system to battery system to supply power for gas engine starts or as second power source for plugin or hybrid vehicle.

The proposed energy harvesting system here is a new versatile broad band energy harvesting system made of array of multiple micro pseudo-linear oscillator cells that is feasible to integrate into wireless sensor, portable or wearable devices such as back-cover of smart phone, tablets, smart watches, and Google glass considering its vertical dimensions can be well below one mm. It can also be built as an independent system/device for energy supply. The energy harvesting system is capable of generating electricity efficiently from any movement either induced by the owner/or host of the devices or from the environment such as wind and water movement. Scaled up the proposed energy harvesting system can be buried underneath road to power street light by converting and storing the useful energy from road traffic movements. Building the proposed energy harvesting system with specified designed large capacitor together into vehicle can improve the vehicle's energy utilization efficiency by harvesting otherwise wasted energy from the vehicle's movement, particularly acceleration such as start and stop, to supply power for gas engine starts or as second power source for plugin or hybrid vehicle.

What is claimed is:

1. An energy harvesting system (EHS) comprising: array of energy harvesting cells.

2. The system of claim 1, wherein said energy harvest system further comprising an energy store reservoir (ESR).

3. The system of claim 1, wherein said energy harvesting system further comprising:
One bottom packaging frame comprising soft magnetic material acting as magnetic shield and forming partially of magnetic close loop;
One top packaging frame comprising soft magnetic materials acting as magnetic shield and forming partially of magnetic close loop.

4. The system of claim 1, wherein said array of energy harvesting cells is arranged as one single layer of cells.

5. The system of claim 1, wherein said array of energy harvesting cells is arranged as multiple layers of cells.

6. The system of claim 1, wherein each of said energy harvesting cells comprising:
At least a conductive pancake coil with multiple turns on a flat plane;
A hollow tube, separated away from the coil with pre-determinate distance and dielectric material, whose dimensions parallel to the flat plane of the coil are bigger than the dimension normal to the flat plane of the coil;
A floating structure containing hard magnet, inside the tube, whose magnetization is normal to the flat plane of the coil and whose dimensions are smaller than the tube with pre-determinate amount at every direction;
Several patterned permanent magnets with pre-determinate number and arrangement around said hollow tube, whose magnetizations point opposite to the magnetization of the hard magnet within the floating structure. The patterned permanent magnets provide not only a sophistical magnetic levitation mechanism for said floating structure containing hard magnet but also the elastic restoring force for said floating structure containing hard magnet;
Said floating structure containing hard magnet, along with said patterned permanent magnets, forms a pseudo-linear oscillator within predetermined frequency range, which works most efficient for energy harvesting at its specified resonant frequencies.

7. The system of claim 6, wherein a collection of said pseudo-linear oscillators with different resonant frequency cross the frequency rang makes the energy harvest system cover a broad band frequency for energy harvesting.

8. The system of claim 6, wherein the resonance frequency of said pseudo-linear oscillator is tunable by adjusting either the arrangement of said patterned permanent magnets; or the length of said hollow tube; or the gap between said floating structure containing hard magnet and said patterned permanent magnets outside said hollow tube.

9. The system of claim 8, wherein said gap between the floating structure and the magnets outside the tube is done by either changing physical distance between said patterned permanent magnets outside said hollow tube; or applying gas pressure on the structures where said patterned permanent magnets locate; or adding electrostatic force by applying voltage between the structures, on which said top and bottom patterned permanent magnets are attached.

10. The system of claim 5, wherein said multiple layers of cells, which are not adjacent to either bottom or top packaging frame of claim 3, further comprising soft magnetic layers, sharing between adjacent layers of cell, locate outside the cell acting as magnetic shields to eliminate the disturbing from any external magnetic field outside the cell.

11. The system of claim 6, wherein said floating structure containing hard magnet has protruded surface pattern to further reduce contact surface between itself and said hollow tube.

12. The system of claim 6, wherein each of said energy harvesting cells produces electricity from said conductive pancake coil due to relative movement between said floating structure containing hard magnet and said conductive pancake coil because of Faraday's law of induction.

13. The system of claim 3, wherein said packaging base is made by normal machining bulk material.

14. The system of claim 3, wherein said packaging lid is made by normal machining bulk material.

15. The system of claim 1, wherein said energy harvesting cells are made on a substrate using either massive volume wafer micro-fabrication processes; or 2D/3D printing together with electroplating methods.

16. The system of claim 1, wherein dimensions of the cell for said energy harvesting system are range from several micrometers to a few hundreds of centimeters depending on particular application of the system.

17. The system of claim 1, wherein said energy harvesting system is used as a key component in an independent energy harvesting device.

18. The system of claim 1, wherein said energy harvesting system is integrated into either a portable or a wearable system to serve as part of built-in energy supply component.

19. The system of claim 18, wherein said portable system is a cell phone, or an electrical tablet, or a laptop.

20. The system of claim 18, wherein said wearable system is an electrical smart watch, or a smart belt, or a Google glass.

21. The system of claim 15, wherein said substrate is made of plastic, or ceramic, or semiconductor.

22. The system of claim 21, wherein said semiconductor has built-in application specific integrated circuit (ASIC) for energy harvesting system.

23. The system of claim 2, wherein said energy store reservoir (ESR) is a capacitor to temporally store the electrical energy produced from said energy harvesting system (EHS) of claim 1.

24. The system of claim 21, wherein said semiconductor has built-in capacitor as said energy store reservoir (ESR) in claim 2.

25. The system of claim 6, wherein said hollow tube is maintained at least partial vacuum or high vacuum (below 1.0×10⁻⁴ Pascal) inside.

26. The system of claim 6, wherein said hard magnet within floating structure is made with its height being larger than the sum of said pancake coil thickness and the distance between said hard magnet and said pancake coil to ensure magnetic flux change within said pancake coil due to the movement of said floating structure containing hard magnet inside said hollow tube.

27. The system of claim 6, wherein each of said energy harvesting cells has multiple coils on both top and bottom of said hollow tube while the separation between the adjacent coils has pre-determinate distance to ensure the change of magnetic flux through the coil when said floating structure containing hard magnet moves along said hollow tube.

28. The system of claim 2, wherein said energy harvesting system (EHS) is further integrated with a wireless sensor/actuator and application-specific integrated circuit (ASIC), which are all fabricated by wafer microfabrication processes to form a self-powered wireless sensor and/or actuator system.

29. The system of claim 28, wherein said self-powered wireless sensor and/or actuator system, working in active mode, comprising: a miniaturized energy harvesting system (EHS) of claim 1, a harvested energy store reservoir (ESR) of claim 2, a rechargeable battery, a wireless work unit, and a power management unit.

30. The system of claim 29, wherein said self-powered wireless sensor and/or actuator system is used to track individual's exercise history or help athletes tracking their progresses in their trainings by monitoring the amount of energy harvested by said miniaturized energy harvesting system (EHS) from the exercise or physical training.

31. The system of claim 28, wherein said self-powered wireless sensor and/or actuator system, working in active mode, comprising: one set of EHS/ESR of claim 2, dual rechargeable batteries, a work unit and a power management unit.

32. The system of claim 31, wherein said self-powered wireless sensor and/or actuator system needs a first time battery charging to turn on the system, and is used for remote or dangerous environmental wireless monitoring and/or actuating.

33. The system of claim 31, wherein said self-powered wireless sensor and/or actuator system is a self-powered falling detection system, working in partial passive mode, which comprises a falling sensor; a wireless emergency unit; a physical activity tracking unit; and a health data unit.

34. The system of claim 33, wherein said self-powered falling detection system continuously harvests energy from its host's physical activities, and tracks its host's physical activities in active mode, while said wireless emergency unit is off at normal circumstance.

35. The system of claim 33, wherein said wireless emergency unit, working in passive modem, which is triggered into active mode by said falling sensor if a falling event happens, and sends out both emergency request and health information for help.

36. The system of claim 28, wherein said self-powered wireless sensor and/or actuator system is a fail-safe system, which comprises redundant dual set of EHS/ESR of claim 2, and dual rechargeable batteries acting as power supplies to enhance the system's reliability.

37. The system of claim 1, wherein said energy harvesting system (EHS) is built as a scaled-up system to harvest energy from vibrations caused by road traffic, and becomes key component of a self-powered city street lighting system.

38. The system of claim 37, wherein said self-powered city street lighting system comprises a scaled-up energy harvesting system of claim 1 buried underneath the road; a harvested energy store unit; and a self-powered lighting control unit.

39. The system of claim 37, wherein said self-powered city street lighting system comprises an energy harvesting system of claim 1 hanged on lighting pole to self-power street and traffic lights in emergency case of stormy weather, which caused the loss of electricity power.

40. The system of claim 29, wherein said wireless work unit is either a wireless sensor system, or a wireless senor and actuator system, or a wireless actuator system.

41. The system of claim 1, wherein said energy harvesting system is attached on vehicle as key component of either accessory or built-in power supply device.
